(19) United States
(12) Patent Application Publication
(10) Pub. No.: US 2021/0262225 A1
(43) Pub. Date: Aug. 26, 2021

(54) Simple-Frame, Easy-To-Install Equipment Screen System

(71) Applicant: Kevin McArthur, Santa Cruz, CA (US)

(72) Inventor: Kevin McArthur, Santa Cruz, CA (US)

(21) Appl. No.: 16/795,922

(22) Filed: Feb. 20, 2020

(51) Int. Cl. E04B 7/04; E04C 3/02

(52) U.S. Cl. CPC E04B 7/045; E04C 3/02

(57) ABSTRACT

A mechanical equipment screen system that's used to hang a wall, façade, signs or other items. Made up of multiple triangular, metal frames that are easily adjusted to roof pitch and other circumstances onsite by twisting a custom rod mechanism to retract or telescope out the upright element of the frames. These frames consist of a base, angle, and upright element that are bolted together. This assembly is anchored to a structure via a prefabricated plate attached to the legs which can be oriented in a variety of ways to accommodate various installation applications. Round posts on the base can penetrate a roof membrane and allows a very simple and standard roofing detail that complies with the roof's warranty. Other embodiments are described and shown.

### CROSS-REFERENCE TO RELATED APPLICATIONS

This application claims the benefit of provisional patent application No. 62/809,901 filed on Feb. 25 of 2019 by the present inventor, which is incorporated by reference in its entirety.

### FIELD OF INVENTION

This relates to mechanical equipment screen systems, which are used to attach to the structure of a building and block various forms of equipment or objects to the public view. Specifically, this is in relation to the framing components of a screen system.

### BACKGROUND OF INVENTION

When putting up a screen, the installer of such systems either must design their own system or buy one that is predesigned or prefabricated for such purposes. When designing a screen system, there are often complications that can result when a good design isn't utilized, or if great care isn't taken to avoid such problems. Four of these major issues exist that should be addressed.

The first issue is the longevity of the frame. This is compromised when the frame incorporates insufficiently durable materials, lacks an appropriate and consistent finish on the material used, the design utilizes joints or connectors that allow inherent weak points in the framing, or the design has flaws that won't allow any of said issues to be addressed. This often results in damage to the frame from the elements of nature, causing rust and/or decay, or destruction of the framing by force of wind on the surface of the screen that is greater than the framing can handle. In some worse cases, this can even cause damage to the structure the screen system is attached to. Naturally, this can even become a safety hazard if components were let loose in the wind and blown in the path of the general public.

Materials commonly used have ranged from wood to steel. Wood is becoming less common, as it does not last through outside weather very long and eventually rots and decays to the point of structural weakness. A solution to this has been to use some sort of metal framing, but without proper reinforcement, such a system often succumbs to the force of wind pushing against the facing material. When enough pressure is applied, the said frame will bend or the fixtures holding it together will break, and the structure will be rendered useless and possibly become a hazard. The U.S. Pat. No. D243853 issued Mar. 29, 1977 to Ejchorszt is made of a metal frame, but the connectors used to hold the tubes together and to attach to the roof are an example of how insufficient fixtures can be utilized, as these are simply thin pieces of metal prone to buckle under significant pressure. U.S. Pat. No. 6,205,719 issued Mar. 27, 2001 to Bruce addresses this with more robust connectors and framing, but aluminum beams are employed in place of steel tube. Aluminum requires bigger or thicker material in order to attain the same structural strength that other materials such as steel innately have in smaller or thinner dimensions. Since Aluminum has been historically a great deal more expensive than steel, this can become a burden to the buyer of such a system and becomes susceptible to vandals wanting to profit on recycling fees. It would therefore be better to not make aluminum a requirement for fabricating such a framing system.

The second issue that the installation of certain frame designs may cause leaks in the roof when attached to the top of the building. When penetrating a roof to attach a screen frame, the attachment allows for water to get into the roof and cause water damage to the interior of the building. Upon installation, there is some roofing work required to seal around the affected roof penetration. Many designs do not allow a sufficient solution of making an attachment watertight. In the design of U.S. Pat. No. D243853, the angled rear support of the frame penetrates at an angle that is hard to roof around since the attachment does not come straight out of the roof. This design is a very common practice with equipment screens. Instead of being able to use a prefabricated roof boot from the roof's manufacturer, a pitch pocket is often utilized. This method requires more labor and is less reliable, often requiring constant maintenance to keep watertight. Ideally, any time something is attached to a roof, the penetration point should not require this sort of attention, staying watertight for at least as long as the said roof does.

Another example is in U.S. Pat. No. 6,782,668 issued Aug. 31, 2004 to Bruce, whereby the design employs rubber gaskets to make watertight the base that is used to attach to the roof. A cap goes over this base, and rubber gaskets are again used to seal screws that secure the cap to the base. Rubber gaskets are prone to decay rapidly over time when exposed to the outside elements, and thus will allow water to leak into the building when said gaskets fail over time.

It should be mentioned that there are designs that attach directly to the roof equipment itself, thus eliminating the need for roof penetration. However, no current design of this type allows sufficient room for the contractor employed to maintain these units to work efficiently. The framing is placed too close together, and due to the nature of a triangular frame and lack of height, one cannot easily maneuver around the unit. In addition, these systems are custom to the equipment they are attached to. When equipment needs to be replaced, a significant cost is incurred to replace the screen as well. Thus, this design is not a convenient solution.

The third issue is the difficulty in assembling and installing the screen framing. Often the design can become very complex, incorporating many little pieces and special joints. These components often are used in the design to improve flexibility and adjustability on site when installing such a system. Referring back to U.S. Pat. No. 6,782,668, one uses custom connectors and joints to improve said flexibility of installation. The issue with this system is that these parts also incorporate many little fixtures and screws that must be individually attached and screwed into complete assembly. When tallied up, more than 40 individual pieces are used to assemble a typical frame onsite. With so many individual pieces, it takes great time and effort to assemble such a design. This makes the assembly very arduous and time consuming and causes the installation to be prolonged and expensive.

On the other hand, when studying U.S. Pat. No. 5,862,637 issued Jan. 26, 1999 to Bruce, we see that the design requires the installer to do onsite welding, as there is lack of adjustability beyond these means. Not only does this require expertise beyond that of most employed in relevant trades, but it also requires an amount of extra equipment to be brought up to the roof. The ability to adjust such a frame so that it accomplishes its' purpose is difficult at best, as it requires skilled precision while welding together each individual frame element.

The last major issue is when designing a system that addresses all these issues, the design becomes too complex and thus becomes expensive to make and to buy. Such complexity can also cause only certain trades with certain skills to be able to install. In some cases, even the most qualified trades are at risk of installing such designs incorrectly when there are many little steps involved to assemble and install, and some steps can be skipped over by accident or misunderstood in how to execute. Incorrect installation can cause serious liability if the screen were to come apart in high wind scenarios and become a safety risk if components, such as the metal facing panel, were to blow into a person in the public.

It should also be mentioned that installation of such complex systems can cost significant time, and because this is usually installed by a contractor of some kind, this time costs money. In the case of the above-mentioned U.S. Pat. No. 6,782,668, this is obvious with so many parts and small connector fasteners involved, and the same can be said about U.S. Pat. No. 6,205,719.

There has been no design that adequately addresses all these issues at once.

### SUMMARY OF INVENTION

The present invention is an improved equipment screen that address the four above mentioned issues. The entire frame is a composition of mostly metal tubing and a number of other metal components which ensures structural durability. The said frame is treated with a weather-proof finish of varying types. It can be shipped fully assembled or partially assembled and is comprised of three major components:
1. A base tube bent at both ends to a 90-degree angle with plates welded to each tip. These plates have holes punched in them to allow below roof attachment. A square plate is then welded near or on the circumference of one bend and a hole punched in the middle, and another metal plate with a hole welded near the opposite bend.
2. An upright tube used to secure the facing material to. The bottom part of the tube has a plate welded to the side of it near the end with a single hole punched in it for attachment to a plate on or near a bend of the base tube. A plate with a hole in it is welded to the top of the tube on the side pointing towards the rear of the frame.
3. A diagonal tube with assembly. Comprising a tube pressed at one end and a hole punched in the pressed area. A threaded component is welded to the end of the tube opposite the pressed area. This threaded component can either be stamped metal, a nut welded to the inside of a washer that can be welded to the tube, or some other assembly or design that accomplishes the purpose of such a component. A rod with opposing threads on each end is screwed into this threaded component. The other end is screwed into a clevis with an opposite thread pattern as the threaded component, and the clevis is attached to the back plate of the base tube via a bolt. A nut and lock washer are already screwed onto the rod, allowing the ability to tighten and lock threads in position.

In the occurrence that additional bracing is needed for added strength or some other design need is required to adapt to the construction application, the design can be modified accordingly to fit individual application per an engineer's consultation.

A weatherproof finish is applied post fabrication, ensuring consistency. When shipped to the installer, these components are assembled together in a triangle shape and fastened together using large and sturdy bolts. Only one adjustment of the frame is normally necessary on site, via twisting the threaded rod from the diagonal tube assembly, for convenience and to accommodate for roof pitch. This allows for a much quicker and simpler installation than other equipment screen systems.

Round legs are employed to penetrate straight down into a roof which allows standard products from any roofing manufacturer to be utilized to make the penetrations watertight and complies to the roofing manufacturer's warranties. Further examination of the following drawings and description will make more apparent the benefits of such a design.

### BRIEF DESCRIPTION OF DRAWINGS

The included drawings and description serve to illustrate how to assemble and operate the present invention. The below drawings and description included with the descriptions above embody and explain the principles of said invention.

FIG. 1 is a perspective behind-view of the equipment screen system with multiple Simple-Frames.

FIG. 2 represents a side-view of the upright member used in assembly of the Simple-Frames.

FIG. 3 represents a side-view of the angle member used in assembly of the Simple-Frames.

FIG. 4 represents a side-view of the base component used in assembly of the Simple-Frames.

FIG. 5 represents a side-view of a detachable base plate optionally used to attach to the base component in assembly of the Simple-Frames.

### DETAILED DESCRIPTION OF THE DRAWINGS

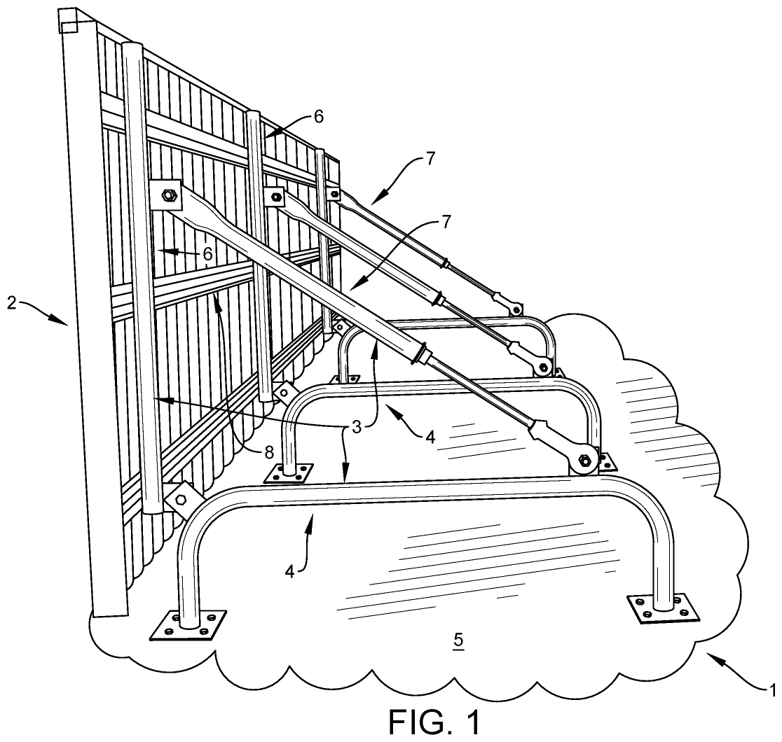

FIG. 1, The Simple-Frame system 1 is shown holding up the screen wall 2 from behind. The Simple-Frame system 1 consists of multiple Simple-Frame units 3. Each Simple-Frame 3 consists of three major members: A base 4 that is responsible for both supporting the other two members and connecting to the attachment surface 5 (such as a structure or the ground), an upright 6 that the screen wall 2 attaches to, and an angle 7 that's used to support the upright 6 against wind force and adjusts the upright 6 to a desired position. All these members will be described in more detail in further diagrams.

All components of the Simple-Frame 3 are made of metal, and preferably coated with a weather-resistant finish. This can be a paint enamel or the components can be treated with a hot-dipped galvanized sacrificial coating, or some other means that will protect the raw material from the outside elements. Additionally, all dimensions including length, width, height and thickness of any of these materials can be altered depending on the needs of the project, whether to strengthen the product or make it fit a less common application.

The screen wall 2 can either be attached directly to the upright 6, or supported by a horizontal support 8, such as hat channel, that is attached to the upright 6. This is achieved through a self-drilling screw, a through bolt, or any other method deemed necessary.

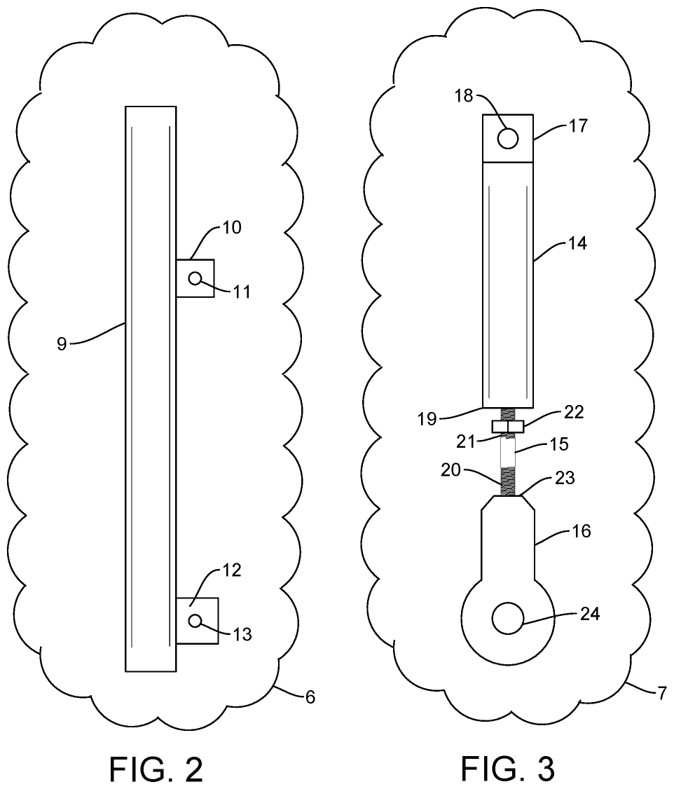

FIG. 2 represents the upright 6, which consists of a metal square or round tube 9 that has a tab 10 with a hole 11 welded near the top, and another tab 12 with a hole 13 welded near the opposite end of the tube. Each end of the tube is left open. This allows the tube 9 to be extended past each tab 10 and 12 for additional length that can be cut down onsite, allowing adjustability for various conditions that require such an adjustment onsite. The nature of these conditions might be unknown at the time of shipment or are difficult to account for with 100% certainty during fabrication. These conditions might include obstacles on the attachment surface 5 below the screen 2 that requires variable lengths of the bottom of the screen 2. Or a Simple-Frame 3 might attach to an elevated area of the surface 5 comparative to the other Simple-Frames 3, requiring the height to be brought down at the top of the tube 9 to match the other Simple-Frames 3.

FIG. 3 represents the angle 7, which consists of a metal tube 14, a custom threaded rod 15, and a clevis 16. The tube 14 has one end flattened 17 with a hole 18 in the flattened area 17. A female-threaded component 19, such as a nut welded to a plate, is attached to the tube 14, via a weld or other method, on the opposite end of the tube 14 from the flattened area 17. The threaded component 19 has either a left-hand thread or a right-hand thread pattern.

The rod 15 has two separate threaded areas, 20 and 21, with one of these areas having a left-hand threaded pattern and the opposing area having right-hand thread pattern. One of these areas 20 or 21 has a nut and lock-washer 22 installed on it.

The clevis 16 has threads 23 that are either left-hand or right-hand thread patterns, and a hole 24 that will receive a bolt that attaches it to the base 4.

The clevis 16 is screwed onto the rod 15 on the side 20 or 21 that has the matching thread pattern of the threads 23 on the clevis 16. The rod 15 is screwed into the threaded component 19 on the side 20 or 21 that matches the thread patterns on the threaded component 19.

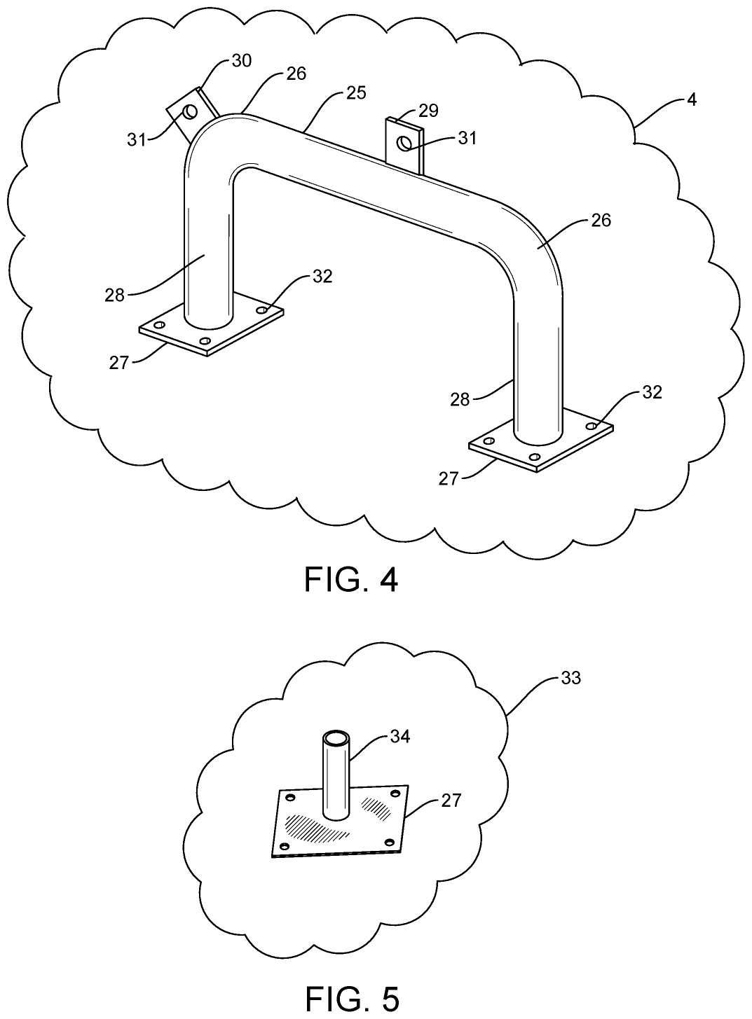

FIG. 4 represents the base 4, which consists of a round metal tube 25 that is bent at each end 26, with base plates 27 attached to the ends of each leg 28. Two metal tabs, back 29 and front 30, are welded to the tube 25, the back tab 29 on the straight part near the rear of the tube 25, and the front tab 30 welded at or near the outside of the bend on the opposite side of the tube from the back tab 29. Each tab 29 and 30 has a pre-punched hole 31, and the base plate 27 has multiple holes 32 pre-punched in them. The base plates 27 are either pre-welded directly to the legs 28 to the base 4 or a detachable design 33 that can be installed onsite, as explained in FIG. 5

FIG. 5 represents a detachable base plate 33 that can be attached to the legs 28 onsite. The base plate 27 is connected to a post 34 that fits inside the legs 28 on the base 4. The post 34 is secured to the leg 28 via flat head bolts, screws, or some other method deemed necessary by a consulting structural engineer that penetrates through the leg 28 and post 34. This would complete the base 4 component post fabrication.

The three components 4, 6, and 7, of the Simple-Frame 3 is assembled by bolting together the following:
The clevis 16 on the angle 7 to the back tab 28 on the base 4 through the holes 24 and 30.
The tube 14 on the angle 7 to the tab 10 on the upright 6 through holes 11 and 18.
The opposite tab 12 on the tube 9 on the upright 6 to the front tab 30 on the base 4 through holes 13 and 30.

This would form the triangular Simple-Frame 3 as seen in FIG. 1. The Simple-Frame 3 is anchored to the attachment surface 5 by fastening or bolting down the base 4 through the holes 31 on the base plate 27 to the attachment surface 5.

Once assembled together and anchored to the attachment surface 5, the rod 15 on the angle 7 can be twisted to extend or retract the top of the upright 6. This allows the installer to achieve a desired angle of the upright 6 which the screen 2 can be attached to, whether this is to compensate for any slope of the attachment surface 5 or simply to achieve a certain look to the screen. After the desired position of the upright 6 is achieved, the nut and lock-washer 22 can be tightened against the tube 14 or clevis 16 on the angle 7 to lock the uprights' 6 position. The screen 2 can then be attached to the upright as already mentioned.

The flexibility of being able to use steel components with a weatherproof finish, such as a hot dipped zinc coating, allows the frames to be sufficiently durable to last many years without additional attention or maintenance. Furthermore, since the base 4 consists of a round metal tube 23, and the legs attached to the base plate 25 can penetrate a roof system straight down, the ability to roof in the base 4 is very easy and simple. All roofing manufacturers have a standard method to roof in such a penetration with a round pipe boot or other method. This eliminates the roofing problems presented when trying to roof in other screen frames that lay flat across the roof, penetrate the roof at an odd angle, or have legs or posts that are oddly shaped, such as any rectangular or square shapes. These screen frames make roofing them in costly, difficult, and time consuming. In addition, the awkwardness of these roofing details can compromise the efficacy of the roof, and often need additional care and maintenance to keep the building watertight. Whereas, on the other hand, the Simple-Frame's 3 posts that are round and penetrate the roof straight down ensure a waterproofing detail that is as viable or more viable than the current roofing system installed. And because these frames do not have to be attached to the roof equipment, adequate working space between the screen and the unit can be achieved, and the replacement of said units does not have to compromise the screen in any way.

The inclusion of separated base plates 27 that attach to the base 4 onsite offers flexibility in how the Simple-Frames 3 are attached to the structure 5 by allowing the base plates 27 to change orientation to match structural members such as roof beams. This eliminates problems that can arise when adequate information was not attainable before fabrication or there was misinformation given to the manufacturer. This might include situations where the roof framing orientation could not be 100% verified because it was not visibly accessible for all the attachment points of the Simple-Frames 3. In this case, the base plate 25 can simply rotate to match the orientation of the roof beams onsite.

In addition, by twisting the rod 15 or cutting the top or bottom of the tube 9 of the upright 6, one can adjust for any roof pitch or slope onsite. Because the installer has the flexibility of being able to adjust for roof pitch onsite while the Simple-Frames 3 are fully assembled, it's possible for the Simple-Frames to ship fully or partially assembled to reduce the amount of labor required onsite. This becomes very beneficial in times of workforce shortages because it's takes less labor to install, whilst also reducing the cost for the end consumer because the cost of installation is reduced. This also means a much simpler assembly and installation that allows any trade to be able to install without special training or skill, whilst also reducing the risk of incorrect installation due to complex designs inherent in other screen systems.

1. An equipment screen framing system that holds up an equipment screen, comprising:
a frame, consisting of a base component, an upright component, and an angled component;
an adjustable base plate secured to the said base component whereby it can be anchored to a structure.
a twistable, threaded component fastened to the said angled component, forming a mechanism that adjusts the angle of the said upright component;
connector plates used to secure the said base, upright, and angled components together;
a means of supporting a screen on the said upright element;
a. The equipment screen assembly of claim 1 wherein said connector plates affix said frame components in relation to each other.
b. The equipment screen assembly of claim 1 wherein the said threaded component is adjustable even after full assembly of said frame.
c. The equipment screen assembly of claim 1 wherein the said base component is U-shaped.
d. The equipment screen assembly of claim 1 wherein the legs of the said base element are round.
e. The equipment screen assembly of claim 1 wherein the said upright can cantilever above the said connector plates for height adjustability.
f. The equipment screen assembly of claim 1 wherein the said frame is made of metal.
g. The equipment screen assembly of claim 1 wherein the said metal is weather resistant.
